(19) United States
(12) Patent Application Publication
(10) Pub. No.: US 2015/0070575 A1
(43) Pub. Date: Mar. 12, 2015

(54) DIGITAL CAMERA UTILIZING SURFACE FOR TEMPORARY MOUNTING

(71) Applicant: Podo Labs, Inc., Santa Clara, CA (US)

(72) Inventors: Edmond Jaehyun LEE, Thousand Oaks, CA (US); Samuel PULLMAN, La Mesa, CA (US); Jae Hoon CHOI, Emeryville, CA (US)

(21) Appl. No.: 14/483,020

(22) Filed: Sep. 10, 2014

Related U.S. Application Data
(60) Provisional application No. 61/876,709, filed on Sep. 11, 2013.

(51) Int. Cl. G03B 17/04; H04N 5/225; G03B 17/12

(52) U.S. Cl. CPC G03B 17/04; G03B 17/12; H04N 5/2252
USPC 348/373

(57) ABSTRACT

One embodiment of the invention is a camera. In this embodiment, the camera includes a housing including camera components and a clasp moveably attached to the housing. The clasp includes a first surface with material for temporarily adhering the clasp and housing to a surface. In addition, the camera includes a joint formed between the camera and the clasp for moveable switching between at least two positions with respect to the housing, with a first position having the first surface of the clasp in a closed position and protected against the housing, and a second position having the first surface in an exposed position for adhering the clasp and housing to a surface.

### CROSS-REFERENCE TO RELATED APPLICATIONS

This application claims priority to United States Provisional Application Ser No. 61/876,709, filed Sep. 11, 2013, which is hereby incorporated by reference in its entirety.

### FIELD OF THE INVENTION

This invention relates generally to the field of cameras and mounting devices for cameras.

### BACKGROUND

Digital cameras, either standalone or included in devices such as phones, tablets, or other electronic devices, have been commercially available for many years. They generally have memory modules to store the image data and the capability to transfer that image data via cables or wireless technologies to other devices. Some standalone cameras are able to connect to the Internet directly to upload data, and some can connect wirelessly to mobile devices to stream images and allow remote shutter control. These digital cameras are usually held by the operator or supported on the body of the operator in order to capture one or more images within the operator's field of vision. Alternatively, they can be mounted on stands such as tripods and set to take photos with a timer or with a remote control.

Digital cameras enjoy advantages of being able to preview images before capture, store higher amounts of data, transfer data to other digital devices, and allow digital image editing at the point of capture. Sharing digital images is very common on social networking sites for the purpose of showing images to friends and, sometimes, to strangers. Sharing pictures online is a common way of communicating to others what one is doing and experiencing. The physical limitations of cameras often render them ineffective for the purpose of allowing the user to be in his/her own photos.

Because cameras usually require an operator to physically trigger the shutter, the physical reach of the operator limits the perspectives a camera can capture. Current solutions are designed to extend the reach of the operator to gain a wider range of perspectives.

Stands, such as tripods or mounts, can steady the camera in a physical position away from the operator. The operator must then use a remote to trigger the shutter remotely, or utilize a timer that will automatically trigger the shutter. Alternatively, the operator can utilize telescoping poles to extend the reach of the camera while still physically supporting its position. If the operator wants to be in the picture from a perspective beyond arm's reach, the operator must use one of these products or enlist a different operator for the picture. However, separating access to the viewfinder results in the operator losing control over how the image is framed and captured.

After capturing the image, the data is usually stored locally on the camera. Many digital cameras require the use of a cable to transfer the data to another device for review. Often, this additional task is necessary if the operator wants to extract the images to upload to social media for sharing.

In addition, extracting the images often requires connecting the digital camera via cable to a computer for later download, an additional task that creates an inconvenience.

A need exists to solve one or more of these problems.

### SUMMARY OF INVENTION

One embodiment of the invention is a feature of the camera that enables temporary, repeatable, stick-on mounting to surfaces in the operator's environment, to eliminate the need to directly hold and operate the camera or else involve additional equipment such as tripods, stands, grips, mounting fixtures, etc. One method is a magnet incorporated into the design of the camera, allowing it to be affixed temporarily and repeatedly to ferrous metals without additional procedures or equipment. For non-ferrous surfaces, one method for reproducing this functionality is with a feature on the camera that allows mounting by suction. One embodiment of this method would be a suction cup. Another embodiment is a material, typically a gel composed of silicon or polyurethane that contains microscopic, concave structures in the surface that functions like thousands of miniature suction cups, dubbed “microsuction.” Another embodiment is a reusable adhesive. The material may induce initial tackiness through microsuction or through microstructures similar to the hairs found on the feet of geckos, and may increase stickiness over time through chemical bonds between the material and mounting surface. An important feature of these methods is that they are repeatable, meaning the adhesion degrades negligibly over time or repeated use, or can be restored by washing clean with water. Another important feature is that these methods allow mounting of the camera in novel and varied locations simply by exposing these materials to the desired surface, without requiring additional equipment or steps. With the camera temporarily affixed to a surface, the camera can take one or more photographs, or videos, including the operator of the camera.

Another embodiment of the invention is a system for taking photographs. In this embodiment, the invention includes a camera within a camera housing, a method or material for affixing the camera to surfaces in the environment, and a remote device that runs an application to control the camera. The method or material can include a magnet, a single suction cup or multiple micro-suction cups, or a reusable and restorable adhesive. In use, the camera housing incorporating these methods or materials can be temporarily affixed to a surface, which allows the camera to take one or more photographs, including of the operator of the camera. The remote device can be, for instance, a smartphone, and this remote device can be used to control the camera so that the operator can view a photo on the camera before taking the image, control taking of the image with the camera, and then control uploading the image from the camera to the remote device. The remote device can communicate with the camera through wireless technologies, such as, but not limited to, Bluetooth or WiFi.

Another embodiment of the invention is a method for the camera to affix temporarily to a variety of surfaces for improved image capturing ability, but avoid sticking undesirably to itself or to the method of transporting it, such as the inside of a bag or pocket. In this embodiment, a flap attached to the main camera housing is lined with the adhesive material and contains the magnet, and can be reversed to alternately expose or conceal the material to the environment, or be removed altogether. In an exposed position, the adhesive material on the flap is affixed to the surface, supporting the weight of the entire device and allowing the camera to adjust viewing angles via a rotating connective joint. In a closed position, the adhesive is concealed within the device by rotating the flap around the connective joint, and a method of reducing exposed surface air via raised texture is used to prevent the adhesive from sticking to the device internally. This method for concealing and exposing the adhesive material allows for convenient use, transport, and storage, and eliminates the need for external protections such as covers or cases.

Another embodiment of the invention is a camera. In this embodiment, the camera includes a housing including camera components and a clasp moveably attached to the housing. The clasp includes a first surface with material for temporarily adhering the clasp and housing to a surface. In addition, the camera includes a joint formed between the camera and the clasp for moveable switching between at least two positions with respect to the housing, with a first position having the first surface of the clasp in a closed position and protected against the housing, and a second position having the first surface in an exposed position for adhering the clasp and housing to a surface.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1a is a front view of one embodiment of the camera housing and clasp according to one embodiment of the invention;

FIG. 1b is a front perspective view of the embodiment of FIG. 1a;

FIG. 1c is a side view of the embodiment of FIG. 1a;

FIG. 1d is a rear view of the embodiment of FIG. 1a;

FIG. 1e is a rear perspective view of the embodiment of FIG. 1a;

FIG. 2a is a perspective view second embodiment of the camera housing and clasp;

FIG. 2b is a side view of the embodiment of FIG. 2a;

FIG. 2c is a top view of the embodiment of FIG. 2a;

FIG. 2d is a second perspective view of the embodiment of FIG. 2a;

FIG. 2e is a perspective view of the embodiment of FIG. 2a that shows the clasp in a swiveled position with respect to the housing;

FIG. 2f is a third perspective view of the embodiment of FIG. 2a that shows the clasp in an opened position with respect to the housing;

FIG. 3a is a front view of a third embodiment of the invention;

FIG. 3b is a rear view of the embodiment of FIG. 3a;

FIG. 3c is a side/top view of the embodiment of FIG. 3a;

FIG. 3d is a perspective view of the embodiment of FIG. 3a that shows the flap opened with respect to the housing;

FIG. 3e is a second perspective view of the embodiment of FIG. 3a that shows the flap opened with respect to the housing;

FIG. 3f is a third perspective view of the embodiment of FIG. 3a;

FIG. 3g is a view of the embodiment of FIG. 3a with the housing and clasp in the closed position;

FIG. 3h is a view of the embodiment of FIG. 3a with the flap opened with respect to the housing;

FIG. 3i is a view of the flap detached from the housing;

FIG. 3j is a view of the flap partially open with respect to the housing;

FIG. 4 is drawing showing how an external lens may be attached to the housing, according to an embodiment of the invention;

FIGS. 5a-5d are a set of drawings showing an alternate embodiment of the camera housing and clasp utilizing a ball-shaped joint or hinge;

FIGS. 6a-6b are close-up views of the suction material on an embodiment of the clasp of the invention;

FIGS. 7a-7c are a set of drawings and example screen captures demonstrating how a mobile application communicates with and controls the camera; and

FIG. 8 is a block diagram of how the camera device in the housing with the clasp can be used to temporarily adhere to a surface for image capture.

### DETAILED DESCRIPTION

The embodiments of the invention can solve one or more of the problems set forth above. In some embodiments, the invention includes a digital camera that can be used to capture images, preview in a viewfinder, and allow for remote control from a mobile device running a mobile application. The digital camera includes a housing that, in some embodiments, has a clasp or flap (which can be magnetic) that enables easy carrying and placement of the camera device. In some embodiments, one side of the clasp features a micro-suction or adhesive surface that enables the camera to adhere to a wide range of surfaces. It may also feature a magnet that enables easy carrying and placement of the camera device. It may also feature a method for concealing and exposing the adhesive surface for convenient carry and storage. This can provide the user with great flexibility in the placement of the camera for additional image perspectives. In some embodiments of the invention, the surface of the clasp having the micro-suction or adhesive surface can move between a protected position in which it is against the housing and an exposed position in which it can be used to adhere to a surface, such as a wall, so that the camera device can be used to take photographs in a controlled manner from a remote location.

In some embodiments, the camera is able to stay physically supported in multiple positions in most environments through use of the micro-suction or adhesive surface. This allows the operator to preview the image and capture it with a mobile device while remaining in the camera's line of sight. The camera can then send the captured images to the mobile device, removing the need for downloading images later using physical cables. The camera, according to some embodiments of the invention, therefore, replaces the need for a user to carry a digital camera along with additional stands or accessories in order to position the camera and trigger it remotely.

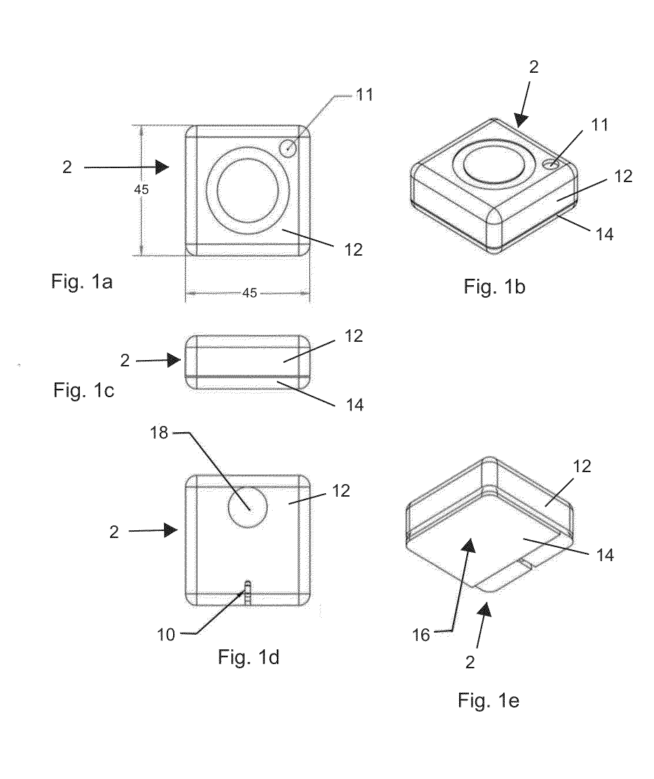

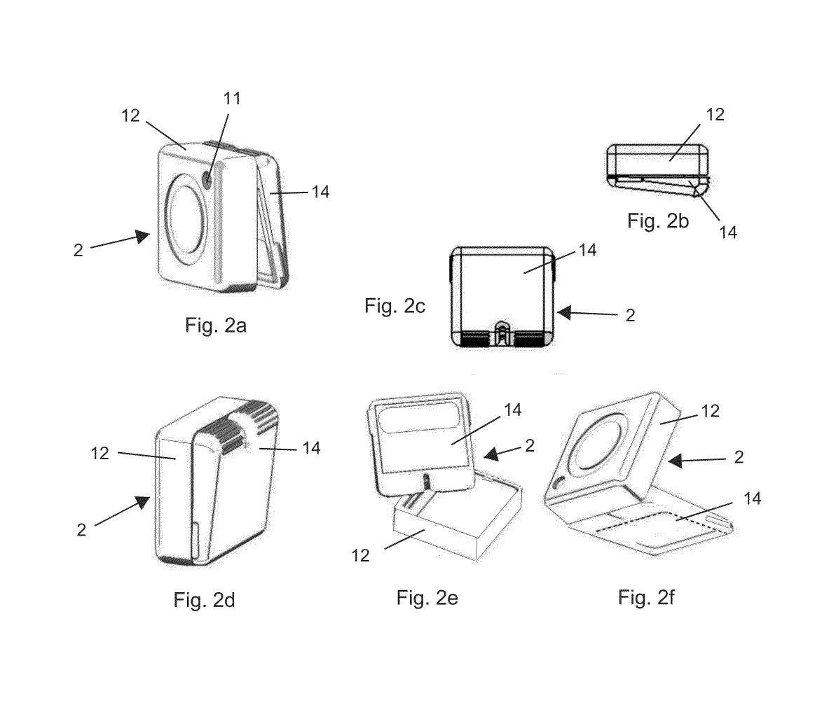

FIGS. 1-2 show a first embodiment of the camera 2 of the invention. FIGS. 1a-1e show several views of one embodiment of the invention, with FIG. 1a being a front view, FIG. 1b being a front perspective view, FIG. 1c being a side view, FIG. 1d is a rear view, and FIG. 1e being a rear perspective view. In this embodiment, the invention includes two parts attached by a swiveling hinge 10, as shown in FIG. 1d. The hinge 10 can include one member on the housing 12 and one member on the flap 14 that engage one another to allow for swiveling. One of those parts is a case or housing 12 that contains the electrical components of the camera, and the other part is a clasp or flap 14 that features a surface 16 that can temporarily adhere to a surface such as a wall. The clasp 14 can also contain a magnet, or the clasp can be, for instance, a magnetic clasp that attaches with one or both of the hinge 10 or a magnet on one or both of the housing and the clasp. In FIG. 1d, the magnet 18 is shown on the housing 12, but in other embodiments the magnet may be on the clasp 14. In addition, the surface for temporarily adhering can be a silicon suction surface, which is shown in FIGS. 1a-1e as the micro suction pad 16, or a polyethylene adhesive pad. The housing also includes an opening 11 for a camera or lens.

The electrical components in the housing 12 can include all of the components of a camera. For instance, these components can include an image sensor, a microcontroller, a Bluetooth module such as a transceiver, flash storage, a battery, capacitive touch sensor, accelerometer, LEDs, and other components that can help for capturing, storing, and sending image data. In addition, the camera housing 12 can also include a lens. As described in greater detail below, the components can also include logic that allows the camera to be controlled remotely from a remote device such as a smartphone. This code can be a software application or firmware that is executed by the microcontroller or by a processor in the housing 12 for the camera. As such, the camera can interact with a mobile device such as a smartphone. For example, in some embodiments, the firmware allows an end user to control various aspects of the camera, and automates the process of sending images and other data from the camera to the remote device. The camera's firmware operates in several different states, and transitions between states occur through interaction with the remote device. As an example, the base state of the camera can be a low-power mode in which the microcontroller is waiting for an indication from a Bluetooth module that the remote device has connected. The microcontroller may also await a signal from the capacitive touch sensor to indicate that the operator is handling the device. It may also await a signal from the accelerometer to register a shake or gesture that indicates the user is intending to turn on the device, minimizing accidental power-ons. This can cause a transition to a fully powered state in which the camera waits for a command from the remote device to transition to a live preview or capture mode. In the live preview mode, low-resolution images from the camera can be sent to the remote device as often as the Bluetooth connection allows, and until the live preview is cancelled or a full resolution image is requested from the remote device. Once a full-resolution image has been requested by the remote device and sent by the camera, the camera can automatically return to its previous state. In some embodiments, the protocol that defines these interactions can be strictly defined and is not specific to any particular implementation or remote device. Therefore, the application on the remote device can provide any graphical user interface or functionality as long as it respects the underlying protocol. The LEDs may represent the various states of the camera by flashing single, multiple, or patterns of lights as indications. The LEDs may also function as a flash to illuminate pictures, or as a timer indicator for timed captures.

FIGS. 2a-2f demonstrate how the camera housing 12 and clasp or flap 14 interact during use. The case/housing 12 contains the camera components and protects them from the environment and physical shock. The housing 12 can also contain a port for attaching a charging cable. FIG. 2a shows a perspective view, FIG. 2b shows a side view, FIG. 2c shows a top view, FIG. 2d shows a second perspective view, FIG. 2e shows a view with the clasp 14 swiveled over the housing 12 on a hinge 10, and FIG. 2f shows the clasp 14 opened with respect to the housing 12.

As shown in FIGS. 2a-2f, in this embodiment, the housing 12 connects to a separate clip/clasp/flap 14 with a with a ball joint hinge 10. The ball post of this hinge can be a feature of the main camera housing 12, while arm-like features on the flap 14 can snap on and off this ball hinge. In other embodiments, the ball post and arm-like feature can be positioned on the other of the housing 12 and flap 14. In this embodiment, one side of the flap is lined with a silicon or polyethylene-based material (on the outer side of the flap) that allows the flap and main housing combination to stick to various surfaces.

FIG. 2a shows a perspective view with the clasp 14 slightly opened with respect to the housing 12. FIG. 2d shows the clasp 14 almost completely shut with respect to the housing 12. FIG. 2e shows the clasp 14 in an opened and swiveled position with respect to the housing 12, and FIG. 2f shows the clasp in a part-way opened position with respect to the housing 12. The clasp 14 can be position in at least an open position, which exposes the adhesive or micro-suction surface, and a closed position in which that surface is protected against the housing 12. In addition, the clasp 14 can also move in a plurality of additional positions (i.e., greater than two) so that the angle of the clasp 14 with respect to the housing 12 can be varied in angle.

The embodiment shown in FIGS. 1-2 can also include a lens for attachment to the housing 12 or clasp 14.

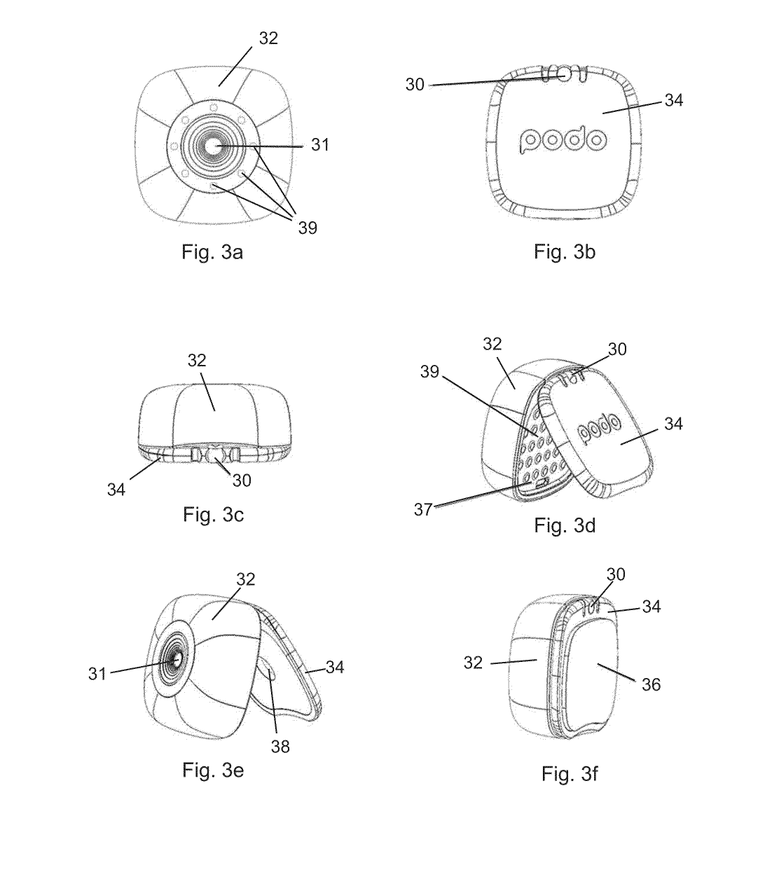

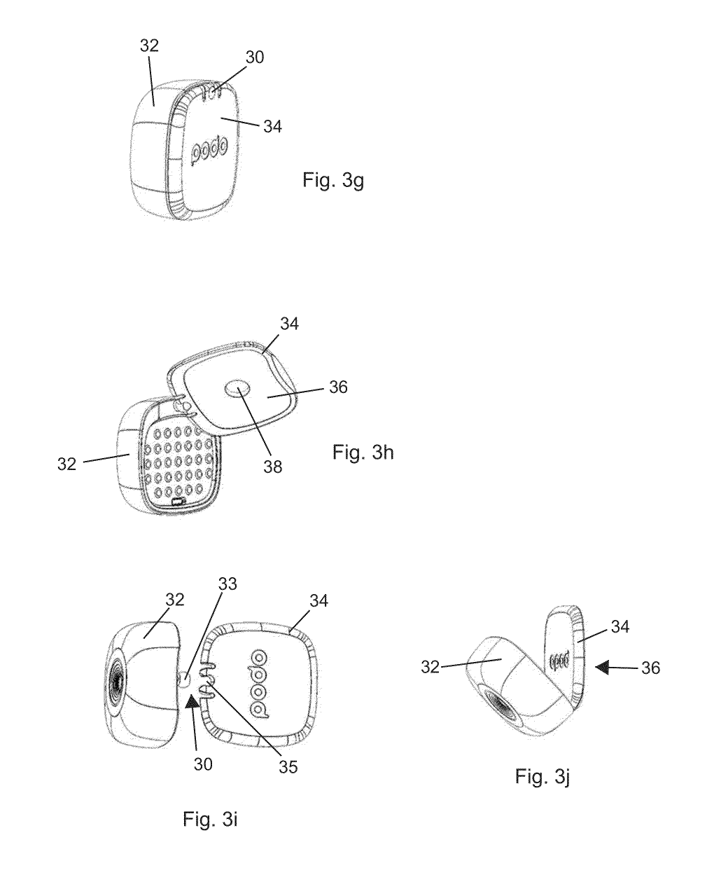

FIGS. 3a-3j show a second embodiment of the invention. In this embodiment, the camera housing 32 can be removably affixed to the flap 34 with a ball joint hinge 30. FIG. 3a shows a front view of the camera housing 32, which can include a camera lens 31 and one or more LEDs 39 for flashes or for indicators. FIG. 3b shows the flap 34 in a rear view. In this view, the micro-suction surface is not visible. FIG. 3c shows a side/top view of the housing 32 affixed to the flap 34. FIG. 3d shows the camera housing 32 with the flap 34 attached thereto, and with the flap 34 partially open with respect to the housing 32. In addition, this figure shows a charging/data port 37 in the housing 32 and a texture 39 to reduce internal sticking on one surface of the housing 32. FIG. 3e shows the camera housing 32 with the flap 34 attached thereto and with the flap 34 in the partially open position. FIG. 3f shows the housing 32 with the flap 34 attached thereto and having the adhesive surface 36 of the flap 34 in the exposed position so that it can be adhered to a surface. FIG. 3g shows the housing 32 with the flap 34 attached thereto, but with the flap in a position such that the adhesive surface is not exposed. FIG. 3h shows the flap 34 partially rotated with respect to the housing 32 through use of the ball hinge joint 30. Opening and rotation using the ball hinge joint 30 allows the flap 34 to change between the closed position of FIG. 3g and the open position of FIG. 3f with the adhesive surface 36 exposed. The flap 34 can be position in at least an open position, which exposes the adhesive or micro-suction surface, and a closed position in which that surface is protected against the housing. In addition, the flap 34 can also move in a plurality of additional positions (i.e., greater than two) so that the angle of the flap 34 with respect to the housing 32 can be varied in angle.

FIG. 3i shows the flap 34 disconnected from the main housing 32. FIG. 3i also shows a ball 33 and a joint 35 for the ball 33, together forming a ball/hinge joint 30. The ball 33 or the joint 35 can be formed in either of the housing 32 or flap 34, with the other of the ball 33 or joint 35 formed in the other of the housing 32 or flap 34. The friction created from tension on the joint 30 connecting the flap 34 and housing 32 allows the housing 32 to be locked with respect to the flap 34 at various angles. This allows the camera and flap 34 to be positioned in a variety of ways on a surface for taking photographs or videos. FIG. 3j shows the flap 34 in a position to be adhered to a vertical surface with the camera maintaining a downward-facing angle utilizing tension in the hinge 30. As such, the embodiment of FIG. 3a-3j shows the adhesive material surface 36 protected in a resting and closed position, then revealed by reversing the orientation of the flap 34 with respect to the housing 32 so that the adhesive surface 36 is exposed in a position so that it can be adhered to a wall or other surface. In addition, as shown in FIGS. 3e and 3h, the flap 34 can contain a magnet 38 on the surface 36 for use in affixing the flap to ferrous materials.

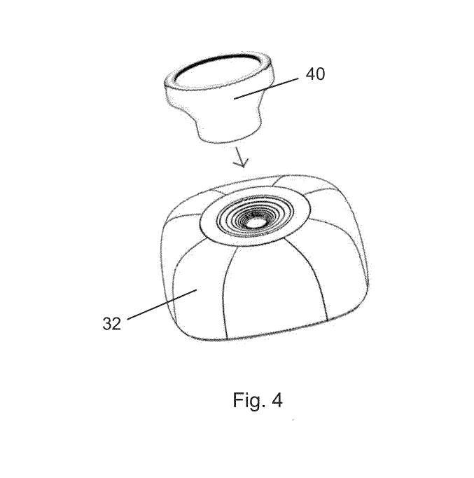

FIG. 4 shows how the camera can include a lens 40 for the camera and can allow for the external connection of additional lenses such as macro, wide-angle, or fish-eye lenses. These lenses can be attached with the use of magnets or other connecting mechanisms. For example, the right side of FIG. 4 shows an external lens 40 that can be attached to the camera housing 32.

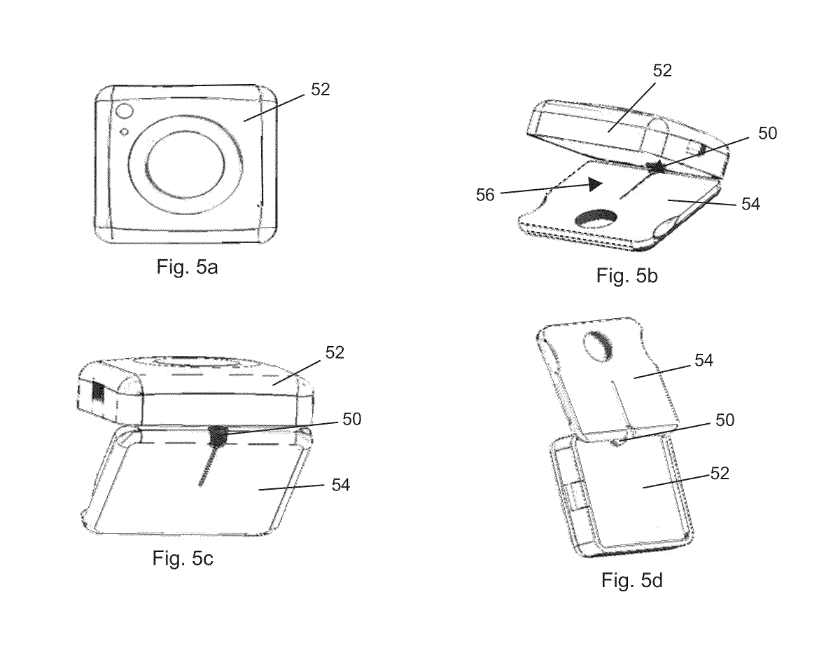

FIGS. 5a-5d show an alternative embodiment of the camera housing 52 and clasp 54 that uses a ball-shaped joint or hinge 50. This figure also demonstrates how the camera housing 52 and clasp 54 interact during use. In this embodiment, the clasp 54 is attached to the camera housing 52 by a ball-shaped joint 50. This ball bearing joint or hinge 50 mechanism allows free range of movement of the clasp 54 with respect to the camera housing 52. Tension created by the clasp 54 on the ball-shaped joint 50, whether by springs, magnets, or other physical force, allows the clasp 54 to maintain a fixed position with respect to the camera housing 52. In the embodiment of FIGS. 5a-5d, the clasp 54 can rotate in a wide range of motion, as well as rotate completely to expose the micro-suction material 56 that is on one side of the clasp 54.

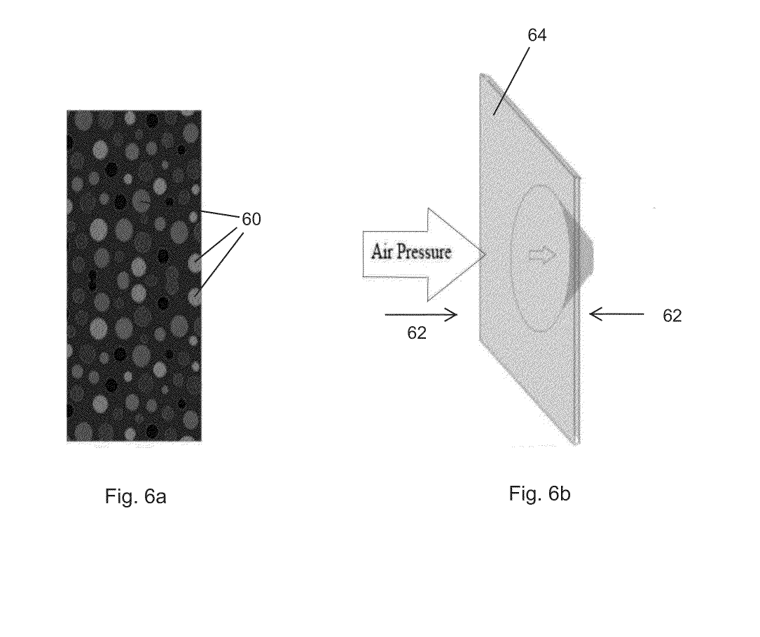

FIGS. 6a-6b show two views of a micro-suction surface that can be used on the clasp according to some embodiments of the invention described above. As shown in the front view of FIG. 6a, the surface of the material is pockmarked by hundreds or thousands of microscopic craters 60 that are designed to trap air and create suction. These craters act essentially as individual “suction cups,” creating a difference in air pressure that helps the silicon, polyurethane, or other gel material adhere to the surface (i.e., a wall) it is pressed against. The small nature of these suction cups allows the material to stick to a wide range of surfaces. This is in contrast to the adhesive material embodiment of the pad described in certain of the embodiments above, which in addition to microsuction or other sticky micro-structures, employs chemical bonds to create adhesion.

The combined suction effect of these hundreds or thousands of small suction cups can create a force strong enough to support the clasp and camera housing in instances where a normal, larger suction cup may not. This allows the use of micro-suctions to support the camera housing on a wall during use. Using a suction-based strategy of adhesion allows the device to adhere temporarily to surfaces without damaging them. In the embodiment of FIG. 6b, the pock-mocked silicon surface creates tiny craters that adhere with suction force to a surface such as a wall. FIG. 6b shows air pressure 62 created by the caters 60 to adhere an embodiment of the flap to a wall 64.

Using this suction-based material allows the camera to be stuck and re-stuck to surfaces over and over again without permanently losing its adhesive properties. If the microscopic suction cups get filled with dirt and other particles, clearing them with water or other physical methods will restore their adhesive powers. The adhesive pad employed for the purpose of this invention shares the same properties.

The micro-suctions can be made from a variety of materials and with a variety of shapes within the scope of the invention. For example, the micro-suctions can be made from silicon, polyurethane, or polyethylene-based materials that are in use to adhere objects to car dashboards, for mounting household objects to walls for organizational purposes, or as docking stands for mobile devices such as smartphones or tablets.

In other embodiments of the invention, the adhering surface on the clasp can be glue-based or can be based on other sticky materials. One embodiment of the adhesive pad that employs tacky micro-structures and chemical bonds to adhere is a formulation of polyurethane or polyethylene. A pre-polymer resin is combined with a curative resin and cast at room temperature to cure. Increasing or decreasing the proportion of curative resin in the mixture increases or decreases the tackiness of the material, respectively. The adhesive pad used in one embodiment of the invention cures in this manner with physical features, such as microsuction, as well as chemical bonds in order to attach to surfaces.

The magnetic clasp is attached to the camera housing with a swiveling hinge. In addition, it can be held against the camera housing magnetically (through magnets on one or both of the camera housing and the clasp). Inserting thin fabric or material between the clasp and the housing without interfering with the magnetic attraction will allow the device to clasp onto that material.

The clasp can also feature ridges on one side that correspond to notches on the main housing. When the ridges are inserted into the notches, the clasp can lock at specific angles with respect to the housing, as shown in the embodiments above.

At a resting position, the suction material is enclosed between the clasp and housing, protecting it from outside elements. The clasp can be lifted and reversed (i.e., through use of the hinge), thus exposing the suction material while retaining the similar, square form factor. By pressing the entire device (i.e., the combined camera housing and clasp) with the suction material in contact with a surface, the camera can adhere to that surface. After use, the magnetic clasp can again be reversed to cover and protect the silicon material.

One advantage of having this portable digital camera that can stick to a variety of surfaces is that it allows the user to easily obtain a wide range of images that would be impossible while holding the camera. For example, without the aid of stands or another person, a user could not take a picture of himself or herself with their entire body and hands in the picture. According to the embodiments of the invention described herein, the user can leave the camera in a desired physical position, step away a distance, preview their photo on their mobile device, and trigger the shutter remotely with a mobile application running on the mobile device.

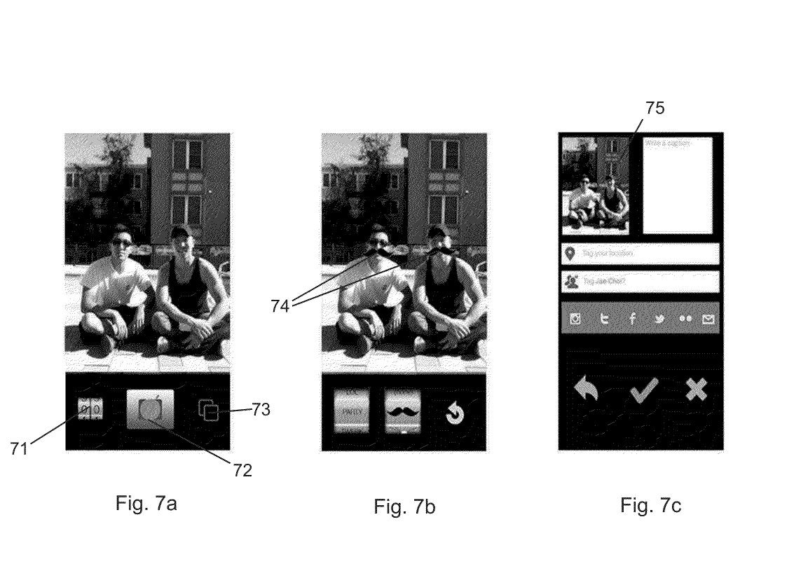

As indicated in FIGS. 7a-7c, in one embodiment, a mobile application on a remote device can receive a streaming feed from the device which demonstrates the field of vision for the device. This can serve as a preview which allows the user to control the composition of their recordings. The application can also send this data to other users of the application with connection to the Internet, allowing a local feed from one camera to be viewed anywhere. The application can also send a signal to the device to release the shutter remotely, allowing the user to record images without physically using buttons on the camera. The application will receive these images from the camera wirelessly and can save them locally on the device running the application or also upload them to online web services. The application can allow users to digitally manipulate their images with filters, image overlays, and other editing tools. Some editing services may require sending the image to an online server, after which the image is sent back to the application after being processed. The application can allow sharing images directly with other users of the application from one mobile device to another. The mobile application may be updated periodically and the interaction between the application and the camera device is not limited by the aforementioned functionalities.

FIG. 7a shows an exemplary screenshot of the live preview function of an application that runs on a user's mobile device. This exemplary shot shows a timer 71, capture button 72, and menu button 73. FIG. 7b shows an exemplary screenshot of such an application that shows that users have an option to edit images. This exemplary screenshot shows an example of using “stickers” 74 on an image. FIG. 7c shows an exemplary screenshot of an upload page of such an application. Users see a thumbnail 75 of their image and can utilize captions, metadata tags, and sharing options.

After capturing the photo or video, the camera can transfer the data wirelessly via Bluetooth or another wireless connection (such as, e.g., WiFi) to the mobile device. This will allow the operator to be present in the photo without carrying larger, more cumbersome devices and accessories besides the camera itself. Other uses may include situations where the operator is not present at all, but can control the device from a mobile device if the camera is connected to an intermediate mobile device as a link.

The operator may not be able to enjoy some of the advantages of flexibly positioning the camera if no suitable surfaces are nearby for the camera to adhere to. The micro-suction surface works best on flatter, non-porous surfaces.

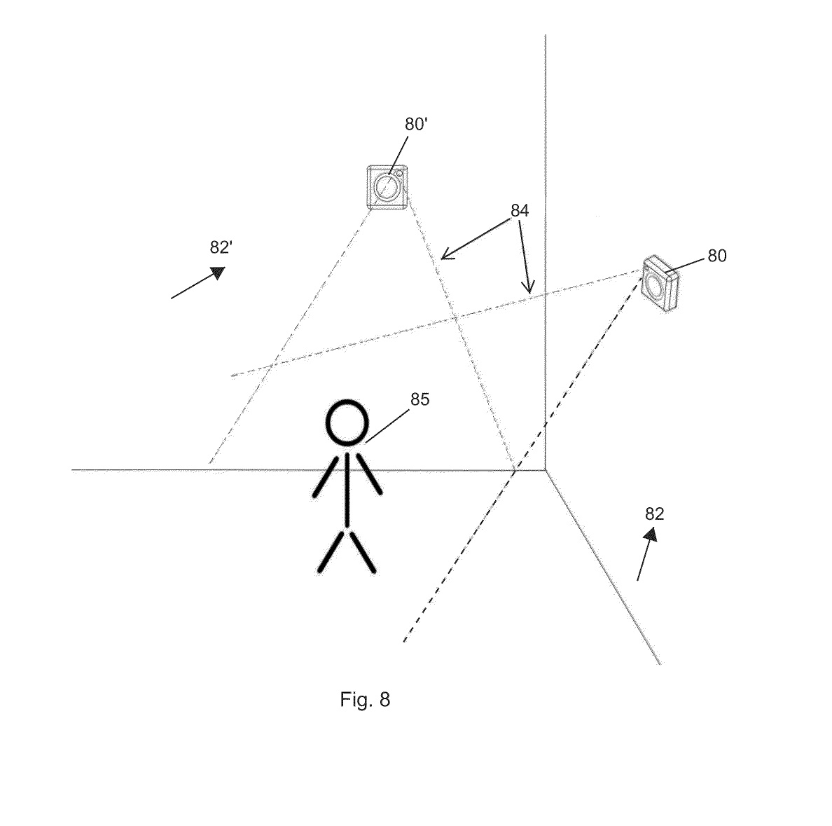

FIG. 8 shows two examples of how an operator 85 can adhere the camera and clasp (together referred to by numeral 80 or 80′) to a wall 82, 82′ for various remote angles for photographs or videos. FIG. 8 shows lines of sight 84 for capture of photos at different angles. A variety of other positions are also possible within the scope of the invention. The invention, therefore, can allow the operator 85 of the camera to be in his/her own photograph. Being in one's own photos can be important, and has become increasingly popular for preserving memories of experiences and communicating present status to others.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways. Also, it is to be understood that the phraseology and terminology employed herein are for the purpose of description and should not be regarded as limiting.

What is claimed is:

1. A camera comprising:
(a) a housing including camera components;
(b) a clasp moveably attached to the housing, the clasp including a first surface with material for temporarily adhering the clasp and housing to a surface; and
(c) a joint formed between the housing and the clasp for moveable switching a position of the clasp between at least two positions with respect to the housing, with a first position having the first surface of the clasp in a closed position and protected against the housing, and a second position having the first surface in an exposed position for adhering the clasp and housing to a surface.

2. The camera of claim 1, wherein the joint is formed by a hinge on one of the housing and the clasp and a ball on the other of the housing and the clasp, wherein the hinge and the ball fit together to allow moving the clasp with respect to the housing.

3. The camera of claim 1, further comprising magnets affixed to the clasp for attaching the clasp to the housing.

4. The camera of claim 1, further comprising magnets affixed to the clasp for attaching the clasp to ferrous materials.

5. The camera of claim 1, wherein the material for temporarily adhering the clasp and housing to a surface comprises micro-suctions.

6. The camera of claim 1, wherein the material for temporarily adhering the clasp and housing to a surface comprises an adhesive material.

7. The camera of claim 1, wherein the joint formed between the camera and the clasp provides for moveable switching in a plurality of positions greater than two so that the angle of the clasp with respect to the housing can be varied.

8. The camera of claim 1, further comprising a lens for attachment to the housing.

9. The camera of claim 1, further comprising a plurality of LEDs affixed to the housing.

10. The camera of claim 1, further comprising one of a charging port and a data port on the housing.

11. A system for taking photographs comprising:
(a) a housing including camera components;
(b) a clasp moveably attached to the housing, the clasp including a first surface with material for temporarily adhering the clasp and housing to a surface, the clasp being switchable between at least two positions with respect to the housing, with a first position having the first surface of the clasp in a closed position and protected against the housing, and a second position having the first surface in an exposed position for adhering the clasp and housing to a surface;
(c) an application to run on a remote device, wherein the application controls the camera components; and
(d) a wireless transceiver associated with the housing for communication with the remote device.

12. The system of claim 11, wherein a joint is formed between the housing and the clasp, the joint being formed by a hinge on one of the housing and the clasp and a ball on the other of the housing and the clasp, wherein the hinge and ball fit together to allow moving the clasp with respect to the housing.

13. The system of claim 11, further comprising magnets affixed to the clasp for attaching the clasp to the housing.

14. The system of claim 11, further comprising magnets affixed to the clasp for attaching the clasp to ferrous materials.

15. The system of claim 11, wherein the material for temporarily adhering the clasp and housing to a surface comprises micro-suctions.

16. The system of claim 11, wherein the material for temporarily adhering the clasp and housing to a surface comprises an adhesive material.

17. The system of claim 11, wherein a joint formed between the camera and the clasp provides for moveable switching in a plurality of positions greater than two so that the angle of the clasp with respect to the housing can be varied.

18. The system of claim 11, further comprising a lens for attachment to the housing.

19. The camera of claim 1, further comprising a plurality of LEDs affixed to the housing.

20. A camera system comprising:
(a) a housing including camera components for taking photographs;
(b) a flap including a first surface with material for temporarily adhering the flap to a surface; and
(c) a joint formed between the housing and the flap for moveable switching the flap between at least two positions with respect to the housing, with a first position having the first surface of the flap in a closed position and protected against the housing, and a second position having the first surface in an exposed position for adhering the flap and housing to a surface.
